(19) United States
(12) Patent Application Publication
(10) Pub. No.: US 2017/0167170 A1
(43) Pub. Date: Jun. 15, 2017

(54) DOOR LATCH DEVICE FOR AN EXTERIOR HANDLE OF VEHICLE

(71) Applicants: Hyundai Motor Company, Seoul (KR); PYEONG HWA AUTOMOTIVE CO., LTD, Daegu (KR)

(72) Inventors: Yongdae Seo, Seoul (KR); Soo Bok Kim, Gyeonggi-do (KR); Soon Won Kang, Gyeonggi-do (KR); Nam Hyeok Lim, Gyeonggi-do (KR); Hyun Duk Cho, Daegu (KR); Ki Ryun Ahn, Daegu (KR)

(21) Appl. No.: 15/252,524

(22) Filed: Aug. 31, 2016

(30) Foreign Application Priority Data
Dec. 11, 2015 (KR) 10-2015-0176734

(51) Int. Cl. E05B 85/26; E05B 81/66; E05B 81/16; E05B 79/08; E05B 81/06

(52) U.S. Cl. CPC E05B 85/26; E05B 79/08; E05B 81/06; E05B 81/16; E05B 81/66

(57) ABSTRACT

A door latch device for an exterior handle of a vehicle is provided. A door latch device for an exterior handle of a vehicle includes a housing within a door, a catch lever within the housing via a first hinge configured to catch or release a striker, a pawl lever mounted at a lower side of the catch level to restrict the catch lever and an exterior lever at a lower side of the pawl lever via a protrusion to transfer a torque force to the pawl lever. An override lever is disposed the third hinge and coupled with the pawl lever and configured to restrict the pawl lever via a hinge. An override link is hinged to the override level of a first protrusion and coupled with the exterior level by a second protrusion and a control portion is configured to restrict operation of the override lever.

### CROSS-REFERENCE TO RELATED APPLICATION

This application claims priority to and the benefit of Korean Patent Application No. 10-2015-0176734 filed in the Korean Intellectual Property Office on Dec. 11, 2015, the entire contents of which are incorporated herein by reference.

### BACKGROUND

(a) Field of the Invention

The present invention relates to a door latch device for an exterior handle of a vehicle and more particularly, to a door latch device for an exterior handle of a vehicle for performing an open operation of a door.

(b) Description of the Related Art

Generally, a door of a vehicle door is stably closed during operation of the vehicle. A lock state is released to allow the door of the vehicle to be opened by operating an interior handle and an exterior handle disposed at an interior side and an exterior side of the door. For example, the vehicle includes a door and a door latch device disposed at an exterior handle. The door latch device for the exterior handle is disposed on the exterior handle and includes a button assembly having a personal identification card (PIC) button, an antenna assembly configured to recognize a smart key and a door latch configured to be operated by the button assembly and the antenna assembly.

Accordingly, when a user of the smart key accesses the vehicle, the antenna assembly is configured to recognize the smart key. When the user presses a PIC button of the exterior handle, an actuator is configured to operate a lock/unlock link to operate a door of the vehicle to an unlock state to release lock of a pawl lever. When the user pulls the exterior handle, an exterior lever is configured to operate the pawl lever to release restriction of a catch lever to release the catch and open the door. As described above, after the user of the smart key presses the PIC button, the door may be opened by two operations for pulling the exterior handle. Since the above door latch device for the exterior handle requires two operations of the user, the user is inconvenienced and the number of components and the cost are increased by the button assembly.

The above information disclosed in this section is merely for enhancement of understanding of the background of the invention and therefore it may contain information that does not form the prior art that is already known in this country to a person of ordinary skill in the art.

### SUMMARY

The present invention provides a door latch device for an exterior handle of a vehicle to improve the convenience of a user by simplifying an operation to open a door and reduce the number of components and a cost.

An exemplary embodiment of the present invention provides door latch device for an exterior handle of a vehicle, the door latch device may include a housing mounted in a door, a catch lever mounted in the housing by a first hinge and configured to catch or release a striker in a vehicle body, a pawl lever mounted at a lower side of the catch level and configured to restrict an operation of the catch lever, an exterior lever mounted at a lower side of the pawl lever coupled with the pawl lever through an extension, and configured to apply an operating force to an exterior handle to transfer torque to the pawl lever; an override lever mounted in the third hinge and coupled with the pawl lever by a hinge and configured to restrict an operation of the pawl lever, an override link hinged to the override level through a first protrusion and coupled with the exterior level by a second protrusion and a control portion configured to restrict an operation of the override lever.

The control portion may include a gear plate integrally formed with a first side of the override lever and an actuator configured to drive a pinion gear coupled to the gear plate. The control portion may further include a torsion spring disposed in the third hinge and configured to operate the override lever in a restriction direction of the pawl lever to be coupled with the housing and the override lever. The pawl lever may further include a release lever coupled with the exterior lever by a protrusion and may be mounted in the second hinge.

The door latch device for an exterior handle of a vehicle according to an exemplary embodiment of the present invention may further include a lock/unlock link configured to adjust a door of the vehicle from a lock state to an unlock state when an end of the lock/unlock link is slidably coupled with the release lever and the catch lever may be configured to release the striker to open the door. The second protrusion of the override link may be configured to be movably coupled with a slot aperture which is formed in the exterior lever.

As described above, an exemplary embodiment of the present invention may inlcude an override level and an exterior lever configured to restrict the movement of a pawl lever and may adjust the override level using a control portion by connecting the exterior lever with the override lever by an override link. Upon recognition of the smart key, the control portion previously controls the override lever. Since the override lever does not hinder the operation of the exterior lever, when the user operates the exterior handle the exterior lever be configured to apply an operating force to actuate the pawl lever. The catch lever may be released and the door may be configured to be opened by actuating (e.g., pulling) the exterior handle. In other words, the open operation of the door may be simplified to improve the convenience of the. Further, since components associated with a touch sensor are removed, the number of components and the cost may be reduced.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary perspective view illustrating a side of a door latch device for an exterior handle of a vehicle according to an exemplary embodiment of the present invention;

FIG. 2 is an exemplary perspective view illustrating an opposite side of a door latch device for an exterior handle of a vehicle according to an exemplary embodiment of the present invention;

FIG. 3 is an exemplary perspective view illustrating main components by removing a housing from FIG. 2 according to an exemplary embodiment of the present invention;

FIG. 4 is an exemplary exploded perspective view illustrating constituent elements which are mounted in a second hinge and a third hinge in FIG. 3 according to an exemplary embodiment of the present invention;

FIG. 5 is an exemplary view illustrating a state before an operation of a control portion upon recognition of a smart key according to an exemplary embodiment of the present invention;

FIG. 6 is an exemplary view illustrating a state after the operation of a control portion according to an exemplary embodiment of the present invention;

FIG. 7 is an exemplary view illustrating a state after an operation of an exterior lever according to an exemplary embodiment of the present invention;

FIG. 8 is an exemplary view illustrating an open start state of a door according to an exemplary embodiment of the present invention;

FIG. 9 is an exemplary view illustrating an open completion state of the door according to an exemplary embodiment of the present invention;

FIG. 10 is an exemplary view illustrating a return state of an exterior lever and a pawl lever after the door is open (before a lock/unlock link ascends) according to an exemplary embodiment of the present invention;

FIG. 11 is an exemplary view illustrating a state before an operation of an exterior lever in a non-operation state of a control portion upon non-recognition of a smart key according to an exemplary embodiment of the present invention; and

FIG. 12 is an exemplary view illustrating an operation completion state of an exterior lever in a non-operation of the control portion according to an exemplary embodiment of the present invention.

### DETAILED DESCRIPTION

Hereinafter, the present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention. The drawings and description are to be regarded as illustrative in nature and not restrictive. Like reference numerals designate like elements throughout the specification.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

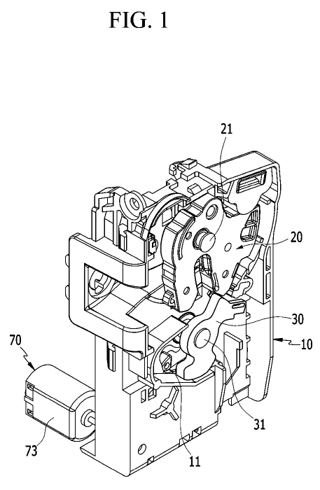

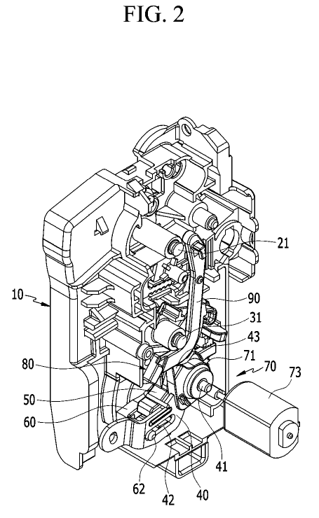

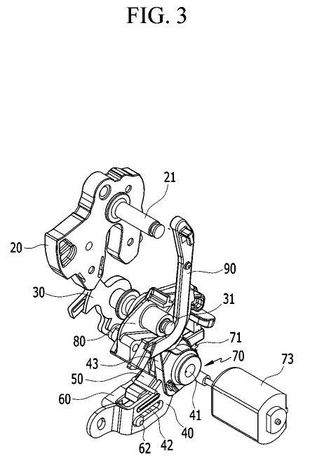

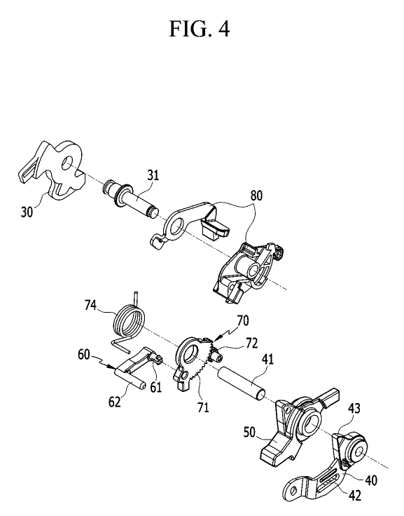

FIG. 1 is an exemplary perspective view illustrating a first side of a door latch device for an exterior handle of a vehicle according to an exemplary embodiment of the present invention. FIG. 2 is an exemplary perspective view illustrating opposite second side of a door latch device for an exterior handle of a vehicle according to an exemplary embodiment of the present invention. FIG. 3 is an exemplary perspective view illustrating main components by removing a housing from FIG. 2. FIG. 4 is an exemplary exploded perspective view illustrating constituent elements which are mounted in a second hinge and a third hinge in FIG. 3.

Referring to FIG. 1 to FIG. 4, the door latch device for an exterior handle of a vehicle according to an exemplary embodiment of the present invention may include a housing 10 mounted at a door, a catch lever 20, a pawl lever 30, an exterior lever 40, an override lever 50, an override link 60 and a control portion 70. As shown in FIG. 1, the catch lever 20 and the pawl lever 30 may be disposed at a first side of the housing 10 (see FIG. 1). As shown in FIG. 2, the exterior lever 40, the override lever 50, the override link 60, and the control portion 70 may be disposed at an opposite second side (e.g., the opposite side) of the housing 10.

Further, the housing 10 may include a communication aperture 11 that forms a step difference to enable the override lever 50 to restrict the pawl lever 30. In other words, the override lever 50 of the second side may be configured to restrict or release the pawl lever 30 of the first side through the communication aperture 11. The pawl lever 30 may be mounted at the housing 10 at a lower side of the catch lever 20 by a second hinge 31 and may be configured to restrict an operation of the lever 20 based on a turning operation.

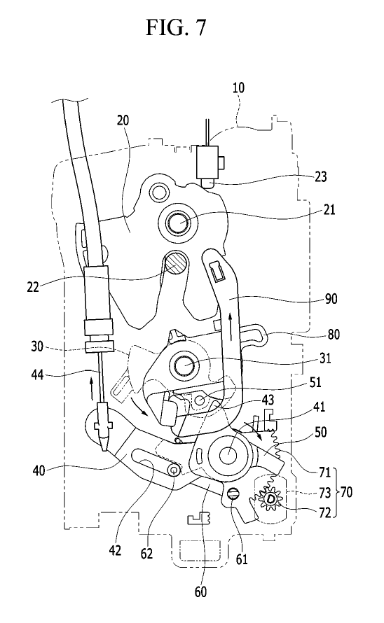

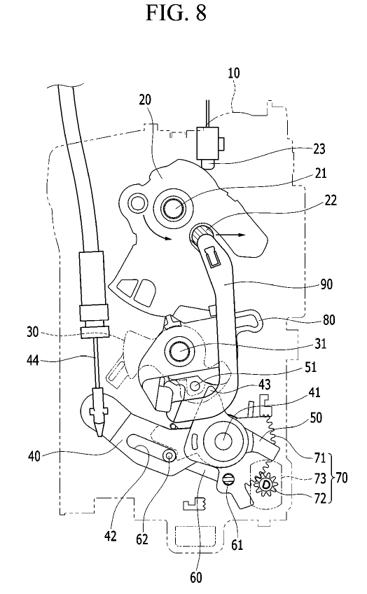

The exterior lever 40 may be mounted at the housing 10 in a lower side of the pawl lever 30 by a third hinge 41. The exterior lever 40 may be connected with the pawl lever 30 while interposing a release lever 80 engaged with an extension 43 therebetween and may be configured to be actuated by an operating force of the exterior handle (not shown) to transfer torque to the pawl lever 30. As shown in FIGS. 7 and 8, the override lever 50 may be mounted at the third hinge 41 within an interior side of the exterior lever 40 and may be configured to engage with the pawl lever 30 by a hinge 51 to restrict the operation of the pawl lever 30.

In other words, when the override lever 50 is rotated in forward and reverse directions at the third hinge 41, the pawl lever 30 may be rotated in reverse and forward and directions at the second hinge 31. The override link 60 may be hinged to the override lever 50 through a first protrusion 61 and may engage a slot aperture 42 of the exterior lever 40 through a second protrusion 62. When the override lever 50 is fixed the override link 60 may be configured to be integrally returned with the exterior lever 40 based on the first protrusion 61. In this case, the second protrusion 62 passes through the slot aperture 42.

The control portion 70 may be configured to restrict an operation of the override lever 50. Accordingly, when the exterior lever 40 is fixed the control portion 70 may be configured to rotate the override lever 50 based on the third hinge 41. In other words, the second protrusion 62 of the override link 60 may be moved through the slot aperture 42 of the exterior lever 40. The control portion 70 may include a gear plate 71 integrally formed with a first side of the override lever 50, a pinion gear 72 coupled with the gear plate 71 and an actuator 73 configured to drive the pinion gear 72. For example, the actuator 73 may be configured by a motor.

When the smart key is recognized, the control portion 70 may be configured to operate the override lever 50 to prevent drive of the pawl lever 30 from being hindered according to the exterior lever 40. For example, the smart key may be recognized by an antenna system (not shown). Accordingly, a welcome system (not shown) included in the vehicle may have previously controlled the actuator 73 of the control portion 70. The control portion 70 may further include a torsion spring 74 disposed in the third hinge 41. The torsion spring 74 may be coupled with the housing 10 and the override lever 50. The torsion spring 74 may be adjusted when override lever 50 is configured to be rotated in a direction to restrict the pawl lever 30.

Additionally, a door latch device for an exterior handle of a vehicle according to an exemplary embodiment may further include a lock/unlock link 90. A release lever 80 may include a component of the pawl lever 30 mounted in the second hinge 31 and may be coupled with an extension 43 of the exterior lever 40. In other words, the release lever 80 may be rotated on the second hinge 31 by an operation of the exterior lever 40. When the exterior lever 40 is rotated in the forward and reverse directions in the third hinge 41, the pawl lever 30 may be rotated in the second hinge 31. In particular, when the override lever 50 restricts the operation of the pawl lever 30 and the exterior lever 40 is rotated in the forward and reverse directions the release lever 80 may be rotated in the reverse and forward directions in the second hinge 31. Further, when the override lever 50 does not hinder the operation of the pawl lever 30 the exterior lever 40 is rotated in the forward and reverse directions in the third hinge 41. Additionally, the pawl lever 30 and the release lever 80 may be simultaneously rotated in the reverse and forward and directions in the second hinge 31.

The lock/unlock link 90 may be configured to be slide-coupled with an end of the release lever 80 and the lock/unlock link 90 elevates by a separate operation tool (not shown). When the catch lever 20 is configured to release a striker 22 to open the door, the lock/unlock link 90 may slidably ascend by an operation tool to adjust a door of the vehicle from a lock state to an unlock state. In particular, a switch 23 configured to sense an operation of the catch lever 20 may be mounted in a housing 10 within a rotation radius of the catch lever 20. When the catch lever 20 releases the striker 22 to open the door, the switch 23 may be turned-on. The switch 23 may be configured to generate an operation signal of an operation tool to operate the lock/unlock link 90. According to the operation signal, the operation tool may be configured to elevate the lock/unlock link 90 to unlock the door of the vehicle. In other words, a user of a smart key accesses the vehicle, and opens a door of a driver′ seat by an operation configured to actuate an exterior handle (not shown), and then may unlock the door.

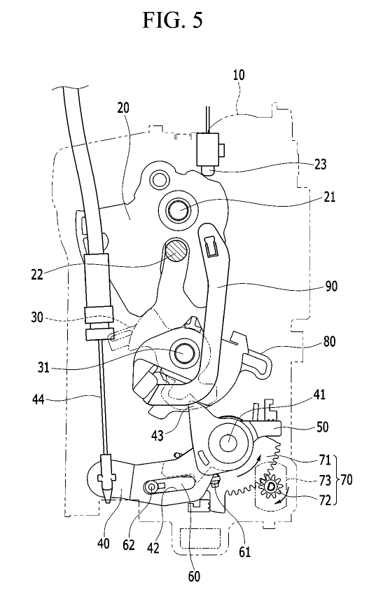

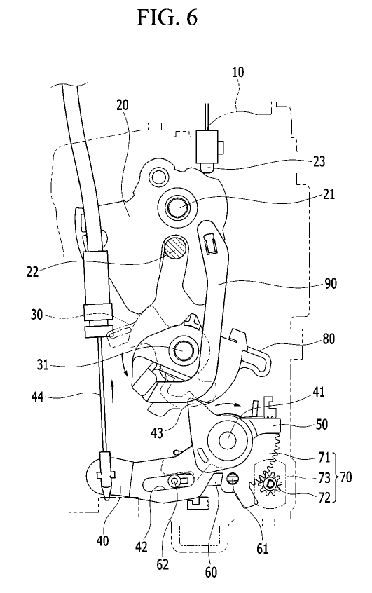

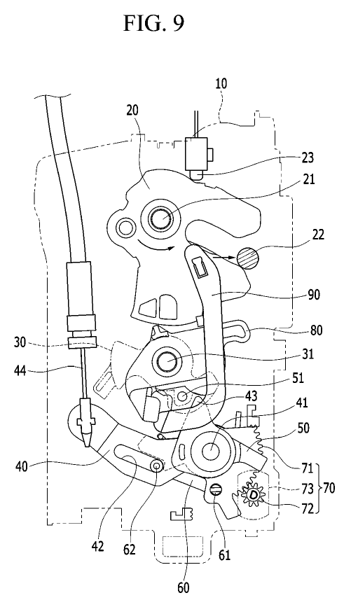

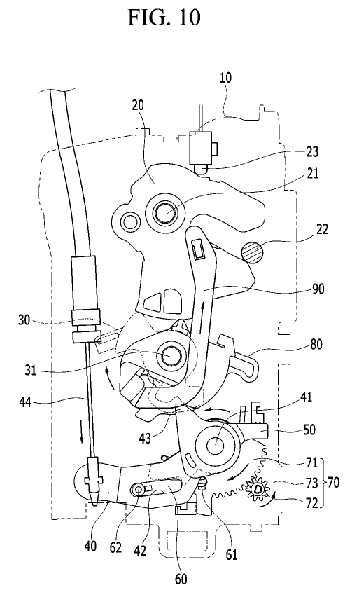

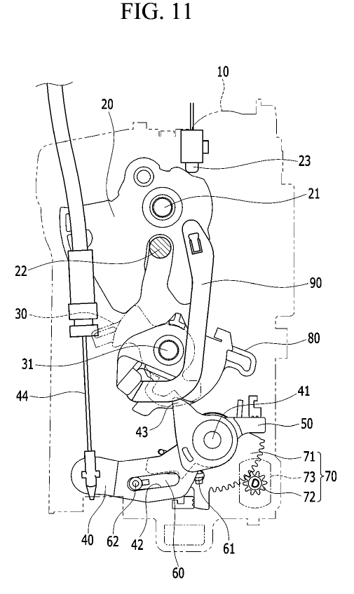

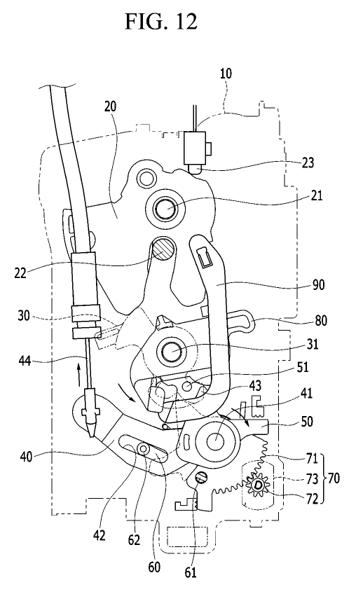

Referring to FIG. 5 to FIG. 10 and FIG. 11 and FIG. 12, an operation state of the door latch device for an exterior handle of a vehicle will be described. FIG. 5 to FIG. 10 illustrate the operation state of the door latch device for an exterior handle of a vehicle when a smart key is recognized. FIG. 11 and FIG. 12 illustrate the operation state of the door latch device for an exterior handle of a vehicle when the smart key is not recognized. FIG. 5 is an exemplary view illustrating a state before an operation of a control portion upon recognition of a smart key. FIG. 6 is an exemplary view illustrating a state after the operation of a control portion. FIG. 7 is an exemplary view illustrating a state after an operation of an exterior lever. FIG. 8 is an exemplary view illustrating an open start state of a door. FIG. 9 is an exemplary view illustrating an open completion state of the door. FIG. 10 is an exemplary view illustrating a return state of an exterior lever and a pawl lever after the door is open (before a lock/unlock link ascends). When the smart key is recognized, the operation of FIG. 5 to FIG. 9 may be repeated.

Referring to FIG. 5, when the user of the smart key accesses the vehicle and an antenna system recognizes the smart key before the user operates the exterior handle the control portion 70 may have previously operated the override lever 50 based on the welcome system. In other words, when the smart key is recognized, the actuator 73 may be configured to drive a pinion gear 72 to rotate a gear plate 71 and an override lever 50 in the third hinge 41. The override lever 50 may be switched to a unrestricted state of the drive of the pawl lever 30. Moreover, the override link 60 may be configured to move through a slot aperture 42 of the exterior lever 40.

Referring to FIG. 6 and FIG. 7, in a state of FIG. 5, an operating force according to the operation of the exterior handle may be transferred to the exterior lever 40 connected with a link 44, and the exterior lever 40 may be configured to be rotated in the third hinge 41. According to the rotation of the exterior lever 40, the release lever 80 and the pawl lever 30 may be configured to be rotated in the second hinge 31. Accordingly, the pawl lever 30 may be configured to release the restriction of the catch lever 20.

FIG. 8 and referring to FIG. 9, when the door starts to open, the catch lever 20 may be configured to be rotated in the first hinge 21 to release the striker 22. When the door completes to open, the catch lever 20 completes release of the striker 22.

Referring to FIG. 10, after the door is open, when the user releases the operating force of the exterior handle, based on a restoring force of the torsion spring 74, the exterior lever 40 and the override lever 50 may be connected to each other by the override link 60 and returned and may be configured to be rotated based on the third hinge 41. Additionally, an end of the lock/unlock link 90 may slidably ascend to the release lever 80 (e.g., lock/unlock link ascending state in FIG. 1) by a separate operating tool, configured to operate the door of the vehicle to an unlock state from a lock state. In other words, the door may be open by an operation configured to actuate the exterior handle and the door may be unlocked. As described above, since a PIC button relation component may be removed in the exemplary embodiment as compared with a conventional art the number of components and costs may be reduced and convenience performance of the user may be improved.

FIG. 11 is an exemplary view illustrating a state prior to an operation of an exterior lever in a non-operation state of a control portion upon non-recognition of a smart key. FIG. 12 is an exemplary view illustrating an operation completion state of an exterior lever in a non-operation of the control portion. When the smart key is not recognized, an operation of FIG. 11 to FIG. 12 may be repeated. Referring to FIG. 11, when the antenna system does not recognize the smart key, the welcome system and the control portion 70 do not operate the override lever 50. In other words, the override lever 50 may be configured to maintain the restriction of the drive of the pawl lever 30. Accordingly, when the exterior lever 40 is operated by an operation of the exterior handle, the release lever 80 coupled with the exterior lever 40 may be configured to rotate in the second hinge 31 and the pawl lever 30 may be configured to maintain a state restricted by the override lever 50. As described above, when the release lever 80 is rotated, the pawl lever 30 may maintain restriction of the catch lever 20 and the catch lever 20 may maintain a restriction state of the striker 22.

An exemplary embodiment of the present invention is disclosed herein, but the present invention is not limited to the disclosed exemplary embodiments, but, on the contrary, is intended to cover various modifications and equivalent arrangements included within the appended claims and the detailed description and the accompanying drawing of the present invention.

### DESCRIPTION OF SYMBOLS

10: housing
11: communication aperture
20: catch lever
21: first hinge
22: striker
30: pawl lever
31: second hinge
40: exterior lever
41: third hinge
42: slot aperture
43: extension
44: link
50: override lever
51: hinge
60: override link
61: first protrusion
62: second protrusion
70: control portion
71: gear plate
72: pinion gear
73: actuator
74: torsion spring
80: release lever
90: lock/unlock link

What is claimed is:

1. A door latch device for an exterior handle of a vehicle, the door latch device comprising:
a housing mounted in a door;
a catch lever mounted in the housing via a first hinge and configured to catch or release a striker disposed within a vehicle body;
a pawl lever mounted at a lower side of the catch level and configured to restrict an operation of the catch lever;
an exterior lever mounted at a lower side of the pawl lever, coupled to the pawl lever through a protrusion, and configured to apply an operating force of an exterior handle to transfer torque to the pawl lever;
an override lever mounted in the third hinge and coupled with the pawl lever by a hinge and configured to restrict an operation of the pawl lever;
an override link hinged to the override level through a first protrusion and coupled with the exterior level by a second protrusion; and
a control portion configured to restrict an operation of the override lever.

2. The door latch device for an exterior handle of a vehicle of claim 1, wherein the control portion includes:
a gear plate integrally formed with a side of the override lever; and
an actuator configured to drive a pinion gear coupled with the gear plate.

3. The door latch device for an exterior handle of a vehicle of claim 2, wherein, the control portion further includes:
a torsion spring disposed in the third hinge configured to operate the override lever in a restriction direction of the pawl lever to be coupled with the housing and the override lever.

4. The door latch device for an exterior handle of a vehicle of claim 1, wherein the pawl lever further includes:
a release lever coupled with the exterior lever by a protrusion and mounted in the second hinge.

5. The door latch device for an exterior handle of a vehicle of claim 4, further comprising:
a lock/unlock link configured to operate a door of the vehicle from a lock state to an unlock state when an end of the lock/unlock link is slidably coupled with the release lever and the catch lever releases the striker to open the door.

6. The door latch device for an exterior handle of a vehicle of claim 1, wherein the second protrusion the override link is movably coupled with a slot aperture formed in the exterior lever.
